(19) United States
(12) Patent Application Publication
(10) Pub. No.: US 2010/0131700 A1
(43) Pub. Date: May 27, 2010

(54) MEMORY INDEXING SYSTEM AND PROCESS

(75) Inventor: Laurent Castillo, Meudon Cedex (FR)

Correspondence Address: OSHA LIANG L.L.P., TWO HOUSTON CENTER, 909 FANNIN, SUITE 3500, HOUSTON, TX, 77010, US

(73) Assignee: GEMALTO S.A, Meudon Cedex (FR)

(21) Appl. No.: 12/447,828

(22) PCT Filed: Oct. 29, 2007
(86) PCT No.: PCT/IB07/03371

§ 371 Date: Feb. 1, 2010

(30) Foreign Application Priority Data
Oct. 31, 2006 (EP) 06291713.3

(51) Int. Cl. G06F 12/02; G06F 12/00

(52) U.S. Cl. 711/103; 711/221; 711/170; 711/E12.002; 711/E12.001

(57) ABSTRACT

The invention relates to a memory index management system. The said system comprises an indexed storage memory, a memory zone containing the index and a microprocessor. The index is built in the form of a hierarchical tree structure and comprises at least two nodes. A node contains an identifier associated with a pointer that references either a node of the index or a memory zone in the storage memory. The content of a node is distributed over a first and a second memory zone that are separate in the memory zone. The first space has a first specific pointer that points to the second space and the second space has a second specific pointer whose value has a blank state.

### FIELD OF INVENTION

This invention relates to memory indexing systems and methods. More specifically, the invention relates to indexing systems and methods for non-volatile memories such as flash memories using a hierarchical tree structure.

### BACKGROUND

In a flash memory, the bytes are managed in groups of bytes called pages. A page is made up of a set of bytes with physically consecutive addresses. All the pages have the same size. The pages are grouped in blocks, all of which are of the same size. A notable characteristic of flash memories is that they can only be erased in whole pages or whole blocks of pages. They may be read and written with granularity below a page, e.g. in the order of a byte or a bit. Depending on the memory, the page size varies from a few bytes to several hundreds of bytes. Block erasing operations generally consume significant amounts of time and memories. Also, most flash memories only withstand a maximum number of block erasing cycles. At the start of their life cycle, the content of such memories is blank, i.e. all the bytes are initialised to a single default value. In general, that blank state is the smallest or largest value that may be given to a byte (00h or FFh).

In order to take account of the constraints relating to the life cycle of the memory and improve performance during memory writing accesses, the principle of logging is known. A logged system constantly changes the physical zone in the memory every time a piece of data is to be written. That principle does away with the need to erase pages before overwriting them when the data are smaller than the page. With a logged system, it is necessary to continuously provide indexing between the physical zones and the logical data.

A Balanced Tree or B tree structure is a dynamic data structure that may be represented in the form of a hierarchy where each element is called a node. The data structure is dynamic because its size changes on the basis of needs. Each node contains data, an ordered list of k identifiers and a list of pointers to the nodes. A node is called the parent of the nodes of which it contains the address pointers. A node whose address is contained in a parent node is called a child node. The node with no parent is called the root. The identifiers contained in a node play the role of access keys to the data specific to that node and the data contained in its child nodes. A pointer is a datum that contains the physical address of a memory space.

A tree is called a d order tree when the number k of node keys ranges from d−1 to 2d−1, except for the root node, which has k number of keys ranging from 1 to 2d−1.

A node with no child is called a leaf. A node with at least one child is called an internal node. A node may contain data, keys and pointers to physical memory addresses.

A B+ type tree is differentiated by the following characteristics:

The data are stored only in leaf nodes,

An internal node has k keys and no more than k+1 child nodes,

The keys contained in the ith child have values ranging from the values of the (i−1)th and ith key of the parent node

Each node is saved in a memory zone that is made up of physically consecutive bytes. The memory zones are characterised by their start address and their memory size.

In a tree, the address of a node is stored in its parent node in the form of an address pointer. That pointer makes it possible to browse the tree while searching for data.

The use of B trees, particularly B+ trees, is known for managing the indexing of non-volatile memories, particularly of the flash type. “An Efficient B-Tree Layer for Flash-Memory Storage Systems” from National Taiwan University suggests the use of B+ trees to manage the indexing of such memories.

One problem is that every time the content of a node is modified, the address of that node is systematically changed. That change calls for erasing the parent node, which involves the part of the memory containing the indexing. The modification of a node leads to a change that is propagated from parent to parent up to the root.

### SUMMARY

With the invention, the number of address changes of a node whose content is changed in order to avoid the systematic change of the address of a node in the parent node when the content of a node is modified.

Unlike a conventional B tree, the invention proposes to store the content of each node in the tree through several memory spaces. These spaces are allocated successively as the need arises.

The invention is a system for managing a memory index. The said system comprises an indexed storage memory, a memory zone containing the index and a microprocessor. The index is built up in the form of a hierarchical tree structure, and comprises at least two nodes. At least one node contains at least one identifier and at least one pointer referencing either an index node or a memory zone in the storage memory. The content of at least one node is distributed over a first and second memory space, separate in the memory zone, the first space having a first specific pointer that points to the second space and the second space having a second specific pointer whose value state is blank.

Advantageously, the second specific pointer may be designed to point to a third memory space. The system may be a logged system. The indexed storage memory and the memory zone containing the index may be brought together in a single memory circuit. The memory zone containing the index may be located in a memory that is distinct from the indexed storage memory.

As a variant, the memory zone containing the index and the indexed storage memory may be located in the same electronic chip or be located in distinct electronic chips.

Preferably, the memory zone containing the index and the indexed storage memory are of the non-volatile type.

In another respect, the invention is a memory index management process. The said system comprises an indexed storage memory, a memory zone containing the index and a microprocessor. The index is built in the form of hierarchical tree structure comprising at least two nodes. At least one node contains at least one identifier and at least one pointer references either a node or a memory zone in the storage memory. The content of at least one node is distributed over a first and second memory space, separate in the memory zone containing the index. The first space has a first specific pointer that points to the second space and the second space has a second specific pointer. The memory spaces specific to each node form a sequential string of spaces. The said string has an initial memory space at a first end and a terminal memory space at a second end. Each space has a specific pointer. The terminal space contains a specific pointer with a blank status. The said sequential string of spaces is modified as the node is updated by positioning the specific blank pointer on the address of a new space, the new space becoming the terminal space.

Advantageously, the modification of a node includes the allocation of a new distinct terminal memory space in the sequential string of memory spaces specific to the node, the writing of data in the new terminal memory space and the writing in the previous terminal memory space of the pointer to the new terminal memory space.

Preferentially, the stage involving the writing of sequencing information to the new terminal memory space may be carried out in the specific pointer of the previous terminal memory space. The content of a node may be reconstructed on the basis of the content of the initial memory space corresponding to the said node, to which the modifications stored in the sequenced memory spaces specific to the node are applied successively in the sequencing order. The modifications applied to the content of the initial memory space may include substitution and/or deletion and/or addition operations. The content of a node may be reconstructed on the basis of the content of the initial memory space corresponding to the said node, to which are applied the modifications stored in the terminal memory space of the string of memory spaces specific to the node.

Advantageously, a node may be compressed in the stages below, it being presumed that an address pointer to the said node is stored in a parent node. The content of the node is then first reconstructed from the string of memory spaces specific to the said node, then the content of the said node is stored in a new initial memory space and lastly the parent node is modified by modifying its pointer to the said node so that it points to the address of the new initial memory space of the said node.

Preferentially, node compression may be triggered as soon as the number of memory spaces of the memory space string of the said node reaches a predefined limit. Node compression may be triggered as soon as the sum of the sizes of the memory spaces of the string of the said node reaches a predefined limit. Node compression may also be triggered as soon as at least one memory space belonging to the string of the said node is located in a memory page that has been identified as needing to be erased.

### BRIEF DESCRIPTION OF DRAWINGS

Other particularities and benefits of the invention will become clear in the light of the description provided as a non-limitative example by reference to the following figures.

FIG. 1 illustrates an IC card system comprising an indexed storage memory, a memory zone containing the index and a microprocessor.

FIG. 2 illustrates an example of embodiment of the invention in a B+ tree.

FIG. 3 illustrates the modification of a node and the compression of a node according to the invention.

### DETAILED DESCRIPTION

The invention may apply to all types of memory indexing system. In particular, it may apply to digital devices containing a processor and memories, portable or otherwise, such as portable computers, cameras, music players and also IC cards. However, one major benefit of the invention is that it reduces the number of erasures and therefore the consumption of flash memories, which is of particular interest for portable devices.

Another benefit of the invention is that it reduces the time taken to update information in the flash memory.

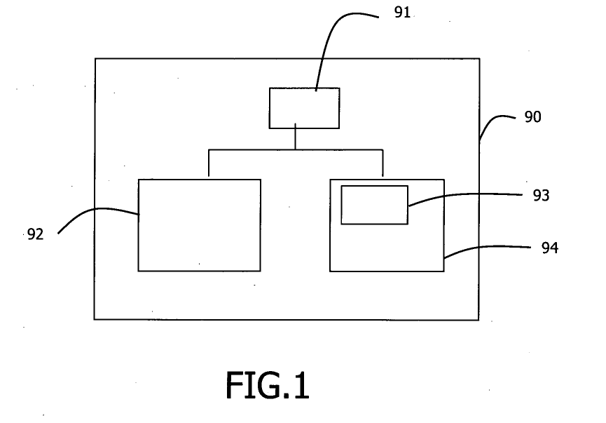

According to the preferred embodiment mode, the index management system is made in an IC card 90 as shown in FIG. 1. The IC card 90 contains a microprocessor 91, a first indexed storage memory 92 connected to the microprocessor and a second memory 94 containing the index 93 of first indexed storage memory 92. The second memory 94 is also connected to the microprocessor. The index 93 is made up in the form of a B+ tree. The first memory 92 and the second memory 94 are preferentially of the flash type made in the same memory partitioned into two distinct memory zones. The system is implemented by the microprocessor 91. The first memory 94 containing the index 93 is managed on the basis of the known principle of logging.

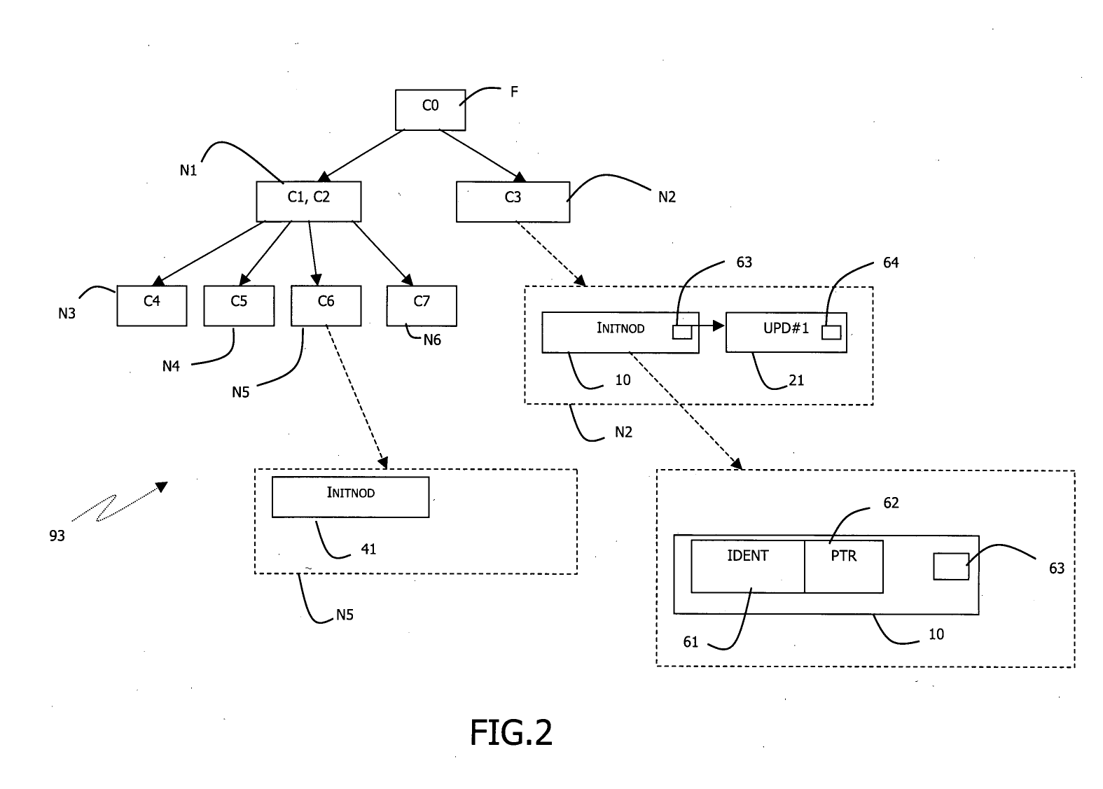

The index 93 is made up of a B+tree represented in FIG. 2. A node F points to two child nodes N1 and N2. Node N1 points to four child nodes N3, N4, N5 and N6. Nodes N2, N3, N4, N5 and N6 are called leaves because these nodes N2-N6 are located at the ends and point to no other node. The leaves of the B+ tree contain pointers to the zones allocated in the first memory 92.

FIG. 2 shows the first level of a close-up on nodes N2 and N5. The content of node N2 is distributed over two distinct memory spaces 10 and 21 belonging to the second memory 94. These two spaces form a sequential string of memory spaces.

FIG. 2 also shows the second level of a close-up on the initial memory space 10 of node N2. Each memory space 10, which is allocated for the storage of the content of a node, has at least an identifier 61, a pointer 62 to a zone of the first memory 92 and a specific pointer 63 to save a link referencing another memory space of the string. The specific pointer 63 remains blank while the memory space is allocated. The specific pointer 63 is then updated with the address of another memory space when a new memory space is allocated during the subsequent modification of the content of a node. Such writing of a blank zone is possible with a flash memory without necessitating the erasure and full rewriting of the content of the memory space containing that zone. Another benefit of the invention is thus that it reduces the stress on memory cells and extends the life of the memory zone containing the index.

The content of node N5 is stored in a memory space 41 belonging to memory zone 94. The sequential string of a memory space of node N5 is reduced to memory space 41 only.

When a new datum is saved in indexed memory 92, the index 93 is updated so as to reference a new memory space that has been allocated to contain the new datum. In that case, index 93 must be modified and a new identifier associated with that new memory space is added to node N2.

The nodes may be stored in memory spaces of the same size or different variable sizes.

The values of pointers to the nodes in the tree may be expressed in absolute or relative addresses.

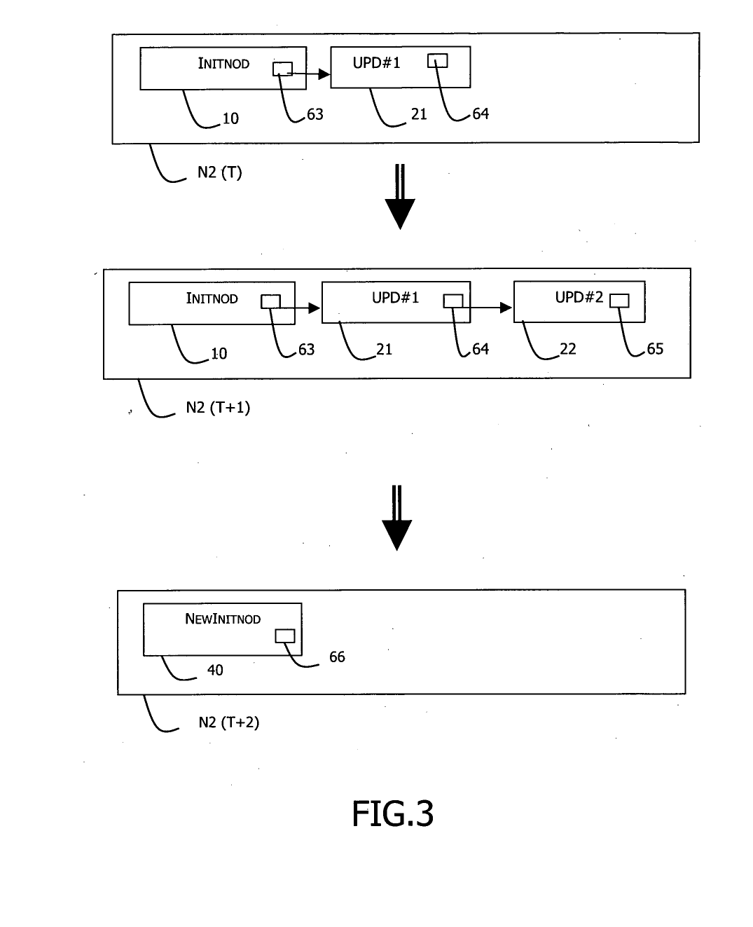

A node N2, changing over time, is represented in several forms in FIG. 3. In the first form N2(T), the content of node N2 is distributed over two memory spaces 10 and 21. The initial memory space 10 contains a specific pointer 63 pointing to the address of the terminal memory space 21. Terminal memory space 21 contains a specific pointer 64 that is in the blank state.

When a new identifier to a zone of the indexed memory 92 must be added to node N2, the content of node N2 must be modified and it becomes node N2(T+1). A new memory space 22 is then allocated in the second memory 94. The new memory space 22 is designed to store the modifications of the content of node N2. The specific pointer 64 of the terminal memory space 21 is updated with a link referencing the new memory space 22. The new memory space 22 becomes the terminal memory space of the string of memory spaces associated with node N2. The initial memory space 10 of node N2 thus remains unchanged in the memory and node N2 may be accessed via an unchanged address. A string of memory spaces is progressively built up in that way. When the content of the same node N2 is subsequently changed, the same mechanism may be repeated and the terminal memory space of the string is updated with the link in the new memory space. Each modification of a node is stored in a new memory space that is sequenced with the previous memory spaces linked to the node.

Node N2 may also be modified when a zone of the first memory 92 is freed up. The identifier corresponding to that zone must then be deleted from the content of node N2. A memory space is then added to the node, which indicates that the identifier is no longer in use.

Node N2 may also be modified when a zone of the memory 92 is moved. The pointer corresponding to the identifier of the moved zone must then be modified in the content of node N2. The identifier may for instance be rewritten in a new memory space with the new address.

The content of the node is reconstructed on the basis of the content of the initial memory space 10 to which are successively applied, in the order of the sequence, the modifications stored in memory spaces 21 and 22, sequentially organised. The content of the initial memory space 10 is modified according to the content of the second memory space 21. The result obtained is then modified on the basis of the content of the second memory space 22.

When the number of memory spaces 10, 21 and 22 belonging to the sequential string associated with node N2 reaches a predefined limit—e.g. three—the compression of the sequential string may be triggered. The totality of the sequential string of memory spaces associated with node N2 may for instance be replaced with a new initial memory space 40 that stores the content of node N2 in the form N2(T+1). The new initial memory space 40 has a specific pointer 66 that is in the blank state. This operation offers the benefit of freeing up memory space in the second memory 94 and improving performance during searches for data in the index tree 93. In order to copy the content of node N2 in a new initial memory space 40, the content of node N2 is first reconstituted from the existing sequential chain as indicated previously. Once the content of the node is rebuilt, the content is written in a new initial memory space 40 associated with node N2. The operation relating to the compression of node N2 ends with an update of node F that points to node N2. The content of node F is modified by replacing the pointer to the address of the initial memory space 10 of node N2 with a pointer to the address of the new initial memory space 40 of node N2. Node F is updated on the basis of the same principle as that used to update node N2.

The preferred example that has been described may be embodied differently. Among others, other variants of embodiment have been indicated below.

As a variant, the content of node N2 may be rebuilt on the basis of the content of the initial memory space 10, to which are applied the modifications stored in the terminal memory space 21. The content of the initial memory space 10 is then modified depending on the content of the second memory space 21.

Compression of the sequential string containing node N2 may be triggered when the sum of the sizes of memory spaces 10, 21 and 22 reaches a predefined limit.

When a page of memory 94 is to be erased, compression of the sequential string containing node N2 may be triggered if one of the memory spaces 10, 21 or 22 is located in the said memory page.

Another benefit of the invention is that the modification of the pointer in the node appears as an atomic operation, i.e. only one operation validates the compression of the sequential string specific to a node. Before the operation of writing the pointer in the parent node, the current tree is still valid, regardless of the writing of the pointer in the parent node. If the card is removed just before the pointer in the parent node is modified, the tree remains valid but is not updated.

In order improve index searches, one possible alternative is to sequence the leaf nodes. That makes it possible to browse the identifiers sequentially.

A possible variant consists in placing the indexed memory 92 outside the card. In that case, the card stores the index 93 enabling access to the data in indexed memory 92.

1. A system for managing a memory index, which system comprises
an indexed storage memory,
a memory zone (94) containing the index, and
a microprocessor,
wherein the index is built in the form of a hierarchical tree structure, and comprises at least two nodes,
wherein at least one node comprising at least one identifier and at least one pointer referencing ether a node in the index or a memory zone in the storage memory (92),
wherein at least one node has its content distributed over a first and a second memory spaces, disconnected in the memory zone, the said memory spaces forming a sequential string of spaces modified as the said node is updated, the first space having a first specific pointer that points to the second space and the second space having a second specific pointer whose value is in the blank state.

2. The system according to claim 1, wherein the second specific pointer is designed to point to a third memory space.

3. The system according to claims 1, wherein said system is a logged system.

4. The system according to claim 1, wherein the indexed storage memory and the memory zone that comprises the index are brought together in a single memory circuit.

5. The system according claim 1, wherein the memory zone comprises the index is located in a memory distinct from the indexed storage memory.

6. The system according to claim 5, wherein the memory zone comprising the index and the indexed storage memory are located in one selected form a group consisting of the same electronic chip and on distinct electronic chips.

7. The system according to claim 1, wherein the memory zone comprises the index and the indexed storage memory are of the non-volatile type.

8. The system according to claim 7, wherein the memory zone comprising the index and the indexed storage memory are of the flash type.

9. A memory index management method in a system comprising an indexed storage memory, a memory zone comprising an index, a microprocessor, the index (93) being built in the form of a hierarchical tree structure, and comprising at least two nodes, at least one node containing at least one identifier and at least one pointer referencing either a node or a memory zone in the storage memory,
wherein the content of at least one node being distributed over a first and a second memory space, separate in the memory zone, the first space having a first specific pointer that points to the second space and the second space having a second specific pointer,
wherein the memory spaces specific to a node forming a sequential string of spaces, the said chain having an initial memory space at a first end and a terminal memory space at a second end, and
wherein each space has a specific pointer, the terminal space containing a specific pointer in the blank state, the said sequential string of spaces is modified as the said node is updated by positioning the specific blank pointer to the address of a new space, the new space being the terminal space.

10. The method for the modification of the node according to claim 9, wherein the modification of the node includes:
the allocation of a new distinct terminal memory space in the sequential string of memory spaces specific to node,
the writing of data in the new terminal memory space and,
the writing in the previous terminal memory space of the pointer to the new terminal memory space.

11. The method according to claim 10, wherein the stage involving the writing of sequencing information to the new terminal memory space is carried out in the specific pointer of the previous terminal memory space.

12. The method of reconstructing the content of a node according to claim 9, wherein the content of a node is reconstructed on the basis of the content of the initial memory space corresponding to the said node to which are successively applied, in the sequencing order, the modifications stored in the memory spaces string specific to node.

13. The method according to claim 12, wherein the modifications applied to the content of the initial memory space include substitution and/or deletion and/or addition operations.

14. The method of reconstruction of the content of a node according to claim 9, wherein the content of a node is reconstructed on the basis of the content of the initial memory space corresponding to the said node to which are applied the modifications stored in the terminal memory space of the string of memory spaces specific to the node.

15. The method of compression of the node according to claim 9, wherein an address pointer to the said node being stored in a parent node:
the content of the node is reconstructed from the string of memory spaces specific to the said node, and
the content of the said node is stored in a new initial memory space, and
the parent node is modified by modifying the pointer to the said node so that it points to the address of the new initial memory space of the said node.

16. The method according to claim 15, wherein node compression is triggered as soon as the number of memory spaces of the string of memory spaces of the said node reaches a predefined limit.

17. The method according to claim 15, wherein node compression is triggered as soon as the sum of the sizes of the memory spaces of the string of the said node reaches a predefined limit.

18. The method according to claim 15, characterised in that node compression is triggered as soon as at least one memory space belonging to the string of the said node is located in a memory page that has been identified as needing to be erased.
